(19) United States
(12) Patent Application Publication
(10) Pub. No.: US 2009/0176049 A1
(43) Pub. Date: Jul. 9, 2009

(54) Towel

(76) Inventor: Jade J. Maughn-Haas, Amsterdam (NL)

Correspondence Address: Maughn-Haas, Jade J., Bogotuin 223, Amsterdam, 1019 PE, NL

(21) Appl. No.: 12/227,874

(22) PCT Filed: May 25, 2007
(86) PCT No.: PCT/IB2007/051995

§ 371 Date: Dec. 2, 2008

(30) Foreign Application Priority Data
Jun. 9, 2006 (GB) 0611558.8

(51) Int. Cl. A47K 10/02; B32B 7/02; D03D 1/00

(52) U.S. Cl. 428/76; 428/212; 428/68

(57) ABSTRACT

The invention relates to a towel (1) for use in drying hair The towel comprises a lower-friction layer (2) for contacting the hair. The lower-friction layer is at least partially water permeable. The towel further comprises a higher-friction layer (3) for retaining water from the hair which passes through the lower-friction layer. The towel may further comprise a second lower-friction layer (4) for contacting the hair wherein the lower-friction layers (2, 4) are arranged either side of the higher-friction layer The lower-friction layer(s) is (are) made of a woven material, e.g. comprising silk. The higher-friction layer is made of a wadding or sponge-like material. Drying hair with such a towel prevents damage to it.

### TECHNICAL FIELD

The present invention relates to a towel, and more particularly to a towel for drying hair.

### BACKGROUND ART

Hair care is an issue of great importance to many people; therefore a large range of hair-styling products is available to meet demand. Products range from simple styling tools like brushes and combs, to more complicated processes that use chemicals, such as perming and dying treatments, alongside electrically heated styling appliances such as irons and tongs.

Unfortunately, in general, the more complicated styling products can have damaging effects on hair, stripping it of its natural moisture, and causing damage to the protective cuticle layer, which gives hair its elasticity, strength and shine.

For example, extensive use of appliances such as hair-dryers and styling tongs can over-dry hair, leaving it brittle and susceptible to breakage, and even brushing or combing hair can lift the cells of the cuticle layer, eventually exposing the cortex and leading to breakage.

These adverse problems are compounded by the everyday effects of climate control, pollution and chemical styling products, all of which lead to further damage.

Thus, frequent styling often results in dry, damaged, lacklustre hair, which eventually becomes prone to frizz, split ends and breakage. Preventing damage to hair is thus an important aspect of hair care.

A variety of products, which aim to protect hair against damage, is available. The most commonly used of these products are conditioners. They are applied to wet hair after washing, and leave a thin coating on each strand of hair, causing the cells of the cuticle layer to close against the shaft, so that hair appears smoother, and has an extra layer of protection.

Deep conditioning treatments, which aim to restore moisture to the cortex of the hair are also available, as are styling products, which apply an additional protective layer to the hair to protect against heat damage caused by electrical hair-styling appliances.

However, it is generally accepted that such products can only protect against further damage; they cannot repair damage to hair.

Moreover, such products can be expensive and time consuming to apply; therefore, it is important for the hair shaft to be as tame and smooth as possible, in order for styling products to be most beneficial, and to reduce excessive build-up of products as a result of overenthusiastic application.

As a result of modern hair styling, which includes perms, hair extensions and dyes, most hair requires unavoidable high maintenance. Yet the purpose of deep conditioners and treatments is often defeated at the end of the washing cycle, i.e., when excess water is removed from the hair with a cotton towel. Hair is at its most vulnerable when wet, but after washing, the seemingly innocuous action of towel drying is often regarded as a vital step towards good hair care, but unfortunately this inflicts unintended damage as a result of rigorous rubbing and tugging, which inevitably causes hair the snag and/or break.

As with aggressive brushing and combing, the friction resulting from rubbing an abrasive cotton towel against hair can cause damage to the cells of the cuticle layer, eventually exposing the cortex and leaving the hair-shaft weak and vulnerable.

Moreover, the friction resulting from towel drying can cause hair, which is already weakened as a result of damage caused by styling, to break at points of weakness.

Friction as a result of towel drying is a particular problem with long hair, where the ends of the hair may be several years old or where the hair has been exposed to repeated chemical processes.

Therefore, hairdressers and other hair care professionals often advise clients with long hair, and/or particularly fragile hair, not to use a towel to dry their hair.

However, without towel drying, it can take a long time for hair to dry naturally. This can be inconvenient in circumstances where it is necessary to style hair after washing. Under these circumstances, it can be tempting to begin styling hair before it is sufficiently dry. This is likely to be less effective than styling hair when it is dry, and may increase the likelihood of damaged hair, if using electrically heated appliances such as irons or tongs.

### DISCLOSURE OF INVENTION

According to an aspect of the present invention there is provided a towel for use in drying hair, the towel comprising: a lower-friction layer for contacting the hair, the lower-friction layer being at least partially water permeable; and a higher-friction layer for retaining water from the hair which passes through the lower-friction layer.

Thus, a towel for drying hair effectively, naturally and safely is provided.

When the towel is used for drying wet hair, the lower-friction layer provides a smooth surface which glides over the strands of hair, avoiding damage to the cuticle layer, unlike a conventional cotton towel. At the same time, the smooth surface of the lower-friction layer is less likely to cause already weakened or fragile hair to break.

As the lower-friction layer is at least partially water permeable, water from the hair passes through this layer into the higher-friction layer, as the hair is rubbed dry with the towel. This water is then retained in the higher-friction layer, so that it does not transfer back into the hair or drip from the towel.

The present invention thus provides a towel that is sufficiently absorbent to be suitable for drying hair while also having a smooth surface that reduces or eliminates damage caused to hair by the towel-drying process.

The towel preferably further comprises a second lower-friction layer for contacting the hair wherein the lower-friction layers are arranged either side of the higher-friction layer.

In this embodiment, there will thus be a smooth surface for contacting the hair on either side of the higher-friction surface; so that the towel can be used in a reversible manner.

The lower-friction layers may fully or partially encapsulate the higher-friction layer.

Where the lower-friction layers fully encapsulate the higher-friction layer, the higher-friction layer is prevented by the lower-friction layers from coming into direct contact with the hair at any point on the towel, and thereby causing damage to the hair.

The lower-friction layer(s) is (are) preferably made of a woven material. The woven nature of the material forming the lower-friction layer(s) contributes to the smoothness of the(se) layer(s).

The higher-friction layer is preferably made of a wadding or sponge-like material. The wadding or sponge-like material is preferably a loose mesh (net) of fibres or other framework that defines air cavities within the layer. In use, water passing through the lower-friction layer is drawn into the higher-friction layer where it then displaces the air in these cavities and is retained therein, giving the towel its absorbent properties.

In a particularly preferred embodiment, the lower-friction layer(s) comprise(s) silk. The higher-friction layer may also comprise silk. Silk is known both for its absorbent and low-friction properties, and is thus particularly suited to the present invention. In a particularly preferred embodiment, the higher-friction layer comprises cotton. In this respect, the higher-friction layer may comprise a silk-cotton blend, preferably blended in the ratio of about 80% cotton to about 20% silk. Like silk, cotton is known for its absorbent properties, and is thus particularly suited to use in the higher-friction layer of the towel. It is also cheaper than silk, and thus makes the towel more economical to produce than if the higher-friction layer were made solely from silk.

Where at least one of the lower friction layer(s) and the higher friction layer is not made entirely of silk, the materials do not tend to cling together, enhancing the performance of the towel.

In instances where two lower-friction layers are provided, these are preferably both made of the same material.

The layers are preferably bonded together at the edges of the towel. In this way, the layers of the towel are held together in close proximity so that water is effectively transferred to the higher-friction layer. Furthermore, the edges of the towel are prevented from fraying or other damage.

The layers are preferably bonded together by a strip of material that is folded around the edges of the layers and secured in place by stitching. In this way, the higher-friction material can be prevented from coming into contact with hair at the edges of the towel.

The strip of material is preferably made of the same material as the lower-friction layer(s). The strip of material may be bias-cut.

In a preferred embodiment, the towel is in the form of an article for wearing on the head. More preferably, the towel may be in the form of a hood, which may be a loose hood.

According to another aspect of the present invention is the use of a towel as described above for drying an object or objects. In this respect, the towel is preferably used for drying hair.

It will be appreciated that the present invention may comprise only one lower-friction layer, so that one surface of the higher-friction (water-retaining) layer is exposed. In this case, the towel can only be used on one side, i.e., with the lower-friction layer in contact with the hair.

Alternatively, a single lower-friction layer could be wrapped around the higher-friction layer to provide a towel with a smooth surface on either side of the higher-friction layer.

It will also be appreciated that different combinations of materials may be used to form the various layers. For example, the higher-friction (water-retaining) layer may comprise solely silk fibres, solely cotton fibres, or both silk and cotton fibres in the same or different proportions. The lower-friction layer or layers may also comprise solely silk fibres, solely cotton fibres, or both silk and cotton fibres in the same or different proportions. Moreover, the layers may also comprise man-made fibres such as rayon or polyester, either on their own or in combination with natural fibres such as silk or cotton. Furthermore, the lower-friction layer or layers may be made of a non-woven polymer. The higher-friction (water-retaining) layer may be a foam, or sponge-like material.

Furthermore, the various layers need not extend over the entire towel. For example, the higher-friction (water-retaining) layer may be smaller than the lower-friction layer or layers. Similarly, the lower-friction layer or layers may each be smaller than the higher-friction (water-retaining) layer. The towel may comprise a border of conventional towelling or other material. Furthermore, the higher-friction (water-retaining) layer may comprise a plurality of water-retaining sections arranged at intervals on or between the lower-friction layer or layers.

In the embodiment described above, the layers are bonded at the edges of the towel and where two sections of towel are joined. However, it will be appreciated that the layers may be bonded together in other ways, for example using adhesive. In particular, the layers may be bonded at any number of places on the towel, for example, by sections of stitching or strips of adhesive. Alternatively, the layers may be bonded over the whole of the towel, for example, by layer(s) of adhesive between the higher-friction (water-retaining) layer and the lower-friction layer or layers.

Alternatively, the lower-friction layer or layers may be applied as a coating, for example a Teflon (RTM) or silicone coating, to the higher-friction (water-retaining) layer.

In the specification, the term ‘towel’ refers to an item suitable for drying an object or objects, such as, but not restricted to, hair. The term ‘low-friction’ or ‘lower-friction’ when describing a layer means relatively low-friction as compared with (an)other higher-friction layer or layers in the towel. The term ‘water permeable’ or ‘at least partially water permeable’ when describing a layer means that water can pass through the layer to at least some extent. The term ‘absorbent’ means able to draw in and retain water to at least some extent.

### BRIEF DESCRIPTION OF THE DRAWINGS

Embodiments of the present invention will now be described with reference to the following drawings in which:

FIG. 1 is a cross-sectional view of a section of a towel embodying the present invention;

FIG. 2 is a cross-sectional view of a different section of a towel embodying the present invention.

FIG. 3 is a side view of a towel embodying the present invention;

FIG. 4 is a front view of the towel shown in FIG. 3;

FIG. 5 shows the towel shown in FIGS. 3 and 4 in use;

FIGS. 6A and 6B are side and back views of the towel shown in FIGS. 3 to 5 in use, and secured to the user's head.

FIG. 7 is a side view of another towel embodying the present invention;

FIG. 8 is a front view of the towel shown in FIG. 7; and

FIG. 9 shows the towel shown in FIGS. 7 and 8 in use.

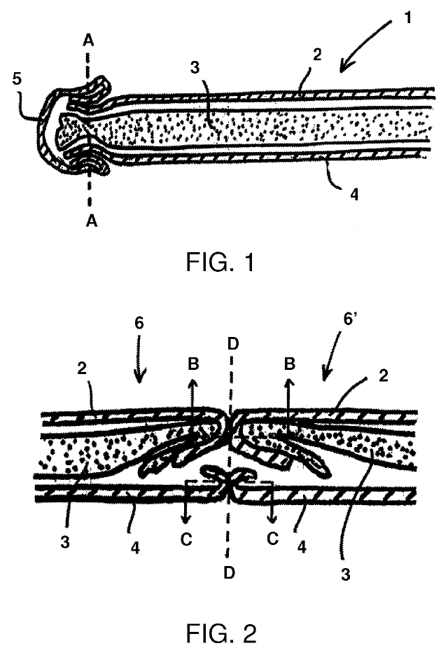

FIG. 1 is a cross-sectional view of a section of a towel 1 embodying the present invention. The material from which the towel 1 is made is a layered (or laminate) material consisting of three separate layers 2, 3, 4. The inner layer 3 is formed of a higher-friction cotton-silk blend wadding material having a loose mesh structure and blended in the ratio 80% cotton to 20% silk. The outer layers 2, 4 are formed of a lower-friction tightly woven pure silk fabric woven from fine silk strands (Jacquard silk).

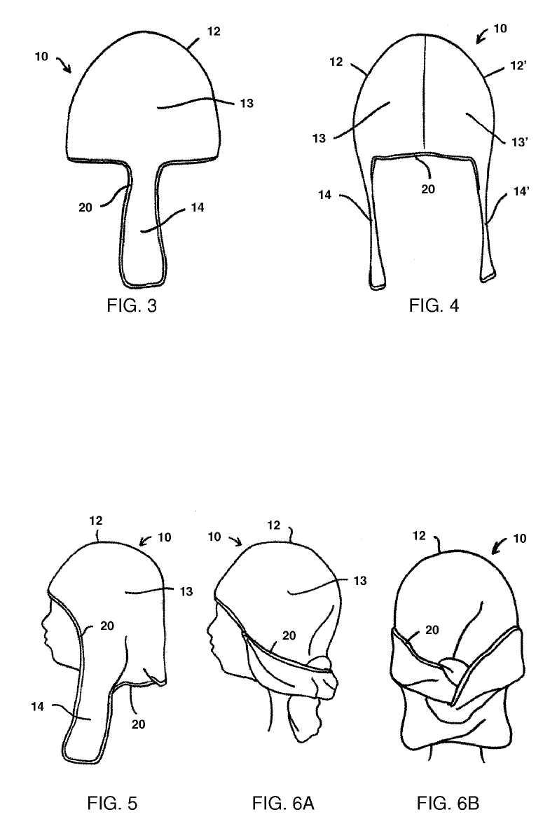

The layers 2, 3, 4 are bonded together at the edges of the towel 1 by a bias-cut strip 5 of the same fabric used for the outer layers 2, 4. The bias-cut strip 5 is folded around the raw edges of the layers 2, 3, 4 as shown in FIG. 1 and secured in place by stitching that extends through the layers of material at A-A, thereby forming the border 20, 120 visible in FIGS. 3 to 9.

The layers are also bonded together where two sections 6, 6′ of the towel 1 are joined, as shown in FIG. 2. Here, the inner layer 3 and the first outer layer 2 of section 6 are bonded together to the corresponding layers of section 6′ by stitching extending through the layers of material at B-B to create a joining seam, such that the raw edges are arranged between the inner layer 3 and the outer layer 4. The raw edges of each section 6, 6′ are folded back from the seam line to lie flat against the respective section of material, and are edge finished in known manner. The outer layers 4 for each section of material are then joined by stitching extending through the layers of material at C-C. The resultant joining seam may be in line with, or slightly offset from the seam joining the layers 2 and 3. Here again, the raw edges are arranged between the inner layer 3 and the outer layer 4, and are edge finished in known manner. Thus, all the raw edges are concealed within the towel 1. The outer layer 4 is bonded to layers 2 and 3 by stitching extending through the layers of material at D-D.

The tightly woven pure silk outer layers 2, 4, provide smooth, low-friction surfaces on either side of the towel 1, which glide over the strands of hair when the towel is used to rub or squeeze the hair dry. Thus, rubbing the hair dry with the towel 1 causes substantially less damage to the cuticle layer of the hair strands than a conventional cotton towel. Also, the smooth surface texture of the outer layers 2, 4, is less likely to cause already weakened or fragile hair to break.

The outer layers 2, 4 are substantially water permeable owing to the water permeable nature of silk itself and to the woven structure of the outer layers 2, 4. Thus, when the towel 1 is in contact with wet hair, water in the hair passes through the outer layers 2, 4 and is drawn into the inner layer 3.

The loose mesh structure of the wadding material of the inner layer 3 provides numerous air cavities within this layer. As water is drawn into the inner layer 3, it displaces the air from these cavities, and is retained therein until the towel 1 dries through evaporation.

It will be appreciated that the embodiment described above is an example only and is not intended to limit the scope of the present invention.

Although a towel embodying the present invention may have a conventional rectangular form, towels shaped to provide an article that can be worn over the head to aid hair drying are also provided. There follows a description of two such towels embodying the present invention.

FIG. 3 is side view of a towel 10 embodying the present invention, and FIG. 4 is a front view of the towel 10. The towel 10 comprises two sections of material 12, 12′, which each comprise a substantially semicircular portion 13, 13′, and an elongate portion 14, 14′ extending from the centre of the straight edge of the semicircular portion 13, 13′. The two sections of material 12, 12′ are joined together along the curved edge of the semicircular portion 13, 13′ to form a hood that fits loosely over the head of a user. As can be seen from FIG. 5, in use, the hood extends to the user's shoulders at the back and sides, and to just above the user's eyes at the front. The elongate portions 14, 14′ extend down the sides of the user's face to fall just below the shoulders at the front of the user's body. The user can thus utilize the elongate portions 14, 14′ to rub longer hair dry when the hair is parted to fall forwards over the user's shoulders, and to secure the towel for easy movement.

FIGS. 6A and 6B show side and front views of the towel 10 in use, in which the elongate portions 14, 14′ are tied up to secure the towel to the user's head.

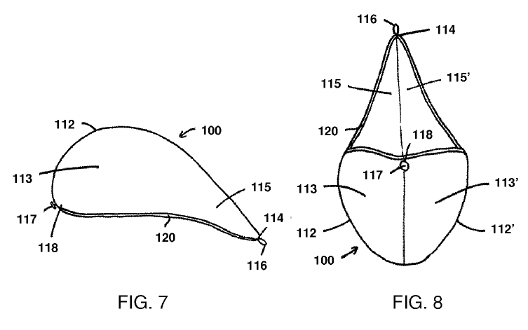

FIG. 7 is side view of another towel 100 embodying the present invention, and FIG. 8 is a front view of the towel 100. As with the towel 1 shown in FIGS. 3 to 6A, 6B, the towel 100 comprises two sections of material 112, 112′. Each section of material 112, 112′ comprises a substantially semi-circular portion 113, 113′, which extends into a tapering portion 115, 115′, tapering to a point 114. The shape of each section of material 112, 112′ is thus defined by two curving edges extending between the corner 118 of the semicircular portion 113, 113′ and the point 114. The two sections of material 112, 112′ are joined together along the longer of these edges, namely the edge which extends from the corner 118, partially around the curved edge of the semi-circular portion 113, 113′, to continue along one edge of the tapering portion to the point 114. When joined together in this manner, the two sections of material 112, 112′ form a hood, with a tail portion 115, 115′ extending therefrom. A button 118 is attached to the towel at the corner 117, and a loop 116 for engaging the button 16 is formed at the point 114.

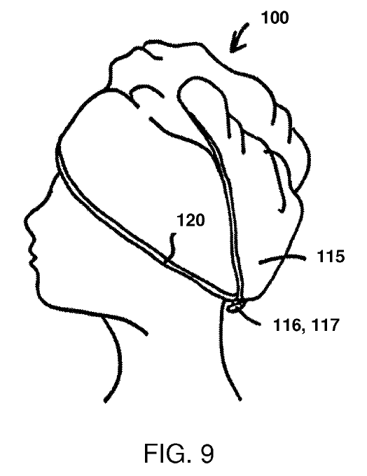

To use the towel 100, the user lowers his/her head and shakes the hair forward. The towel 100 is then placed so that the hood portion fits loosely over the head, with the button 117 located at the nape of the neck. The user's hair will then fall within the tail portion, which is then twisted around the hair, brought back over the top of the user's head, and secured at the nape of the neck by the button 118 and the loop 116. As can be seen from FIG. 9, this results in a turban-like arrangement.

Of course, the loop 116 may be located at the corner 118, and the button 117 may be located at the point 114. Alternatively, any other suitable fastening means could be used in place of the loop 116 and button 117.

Comparison between a silk-cotton composite towel (SCT) according to an embodiment of the invention and a normal cotton towel (CT):

CT is bath cotton towel with embroidery, face side in blue and back side in white.

SCT is a composite towel comprising three layers with sequence silk fabric/fleece/silk fabric. Face sides of silk fabric exposed on the top and bottom surface of the composite. Cover fabrics—No. 63513, pure silk 507, white in colour. The cotton fleeces' technical face is felt and the technical back is plush; raw white in colour. This embodiment is an example only and is not intended to limit the scope of the present invention.

Based on a test done on the low-stress mechanical properties using the Kawabata Evaluation System for Fabrics (KES-FB system for low-stress mechanical properties: e.g. surface friction), the surface friction property and the surface roughness property revealed that the silk-cotton composite towel performs better than the cotton towel due to its lower coefficient of friction (MIU) and lower surface roughness (SMD).

The following table shows measurements performed on 3 samples of CT and 3 samples of SCT:

### [Table 1]

TABLE

| Sample Surface Property | Towel (CT) | Composite Towel (SCT) |
|---|---|---|
| Coefficient of Friction | 0.571 | 0.345 |
| (MIU) | | |
| Mean Deviation of MIU | 0.0184 | 0.0251 |
| (MMD) | | |
| Mean Geometrical Surface | 5.368μ | 2.313μ |
| Roughness (SMD) | | |

Based on the test for water absorbtion from the KES-FB system, (EN14697:2005 Annex B) it was found that the final absorbed water content of the SCT is much higher than that of the CT.

Based on the test for warmth retention from the KES-FB system, (ASTM D1518-85 (2003)) it was found that the warmth keeping ability of the SCT is higher than that of the CT.

1. A towel (1) for use in drying hair, the towel comprising:—a lower-friction layer (2) for contacting the hair, the lower-friction layer being at least partially water permeable; and a higher-friction layer (3) for retaining water from the hair which passes through the lower-friction layer.

2. A towel as claimed in claim 1 further comprising a second lower-friction layer (4) for contacting the hair wherein the lower-friction layers are arranged either side of the higher-friction layer.

3. A towel as claimed in claim 2 wherein the lower-friction layers (2, 4) fully or partially encapsulate the higher-friction layer (3).

4. A towel as claimed in claim 1 wherein the lower-friction layer is made of a woven material.

5. A towel as claimed in claim 1 wherein the higher-friction layer is made of a wadding or sponge-like material.

6. A towel as claimed in claim 1 wherein the lower-friction layer comprises silk.

7. A towel as claimed in claim 1 wherein the higher-friction layer comprises cotton.

8. A towel as claimed in claim 1 wherein the higher-friction layer comprises a cotton-silk blend.

9. A towel as claimed in claim 8 wherein the higher-friction layer comprises cotton and silk in the ratio of about 80% cotton to about 20% silk.

10. A towel as claimed in claim 3 wherein the lower-friction layer(s) is (are) made of a woven material.

11. A towel as claimed in claim 3 wherein the higher-friction layer is made of a wadding or sponge-like material.

12. A towel as claimed in claim 3 wherein the lower-friction layer(s) comprise(s) silk.

13. A towel as claimed in claim 3 wherein the higher-friction layer comprises cotton.

14. A towel as claimed in claim 3 wherein the higher-friction layer comprises a cotton-silk blend.

15. A towel as claimed in claim 14 wherein the higher-friction layer comprises cotton and silk in the ratio of about 80% cotton to about 20% silk.

16. Use of a towel as claimed in claim 1 for drying an object or objects.
